(19) United States
(12) Patent Application Publication
(10) Pub. No.: US 2015/0279235 A1
(43) Pub. Date: Oct. 1, 2015

(54) NUTRITION MANAGEMENT SYSTEM AND NUTRITION MANAGEMENT PROGRAM

(71) Applicant: Seiko Epson Corporation, Tokyo (JP)

(72) Inventor: Akiko YAMADA, Suwa (JP)

(21) Appl. No.: 14/672,545

(22) Filed: Mar. 30, 2015

(30) Foreign Application Priority Data
Mar. 31, 2014 (JP) 2014-071232

(51) Int. Cl. G09B 19/00; G06F 17/30

(52) U.S. Cl. CPC G09B 19/0092; G06F 17/30864

(57) ABSTRACT

A nutrition management system includes a user information calculation processing unit that performs a process of calculating a required nutrient amount of a user based on user information and calculating nutrient excess or deficiency information of the user based on the required nutrient amount and nutrient analysis result information of the user, a dish information search processing unit that searches for the dish information based on an instruction from the user, and a dish information calculation processing unit that calculates a nutrient amount acquirable from a dish of the dish information and supplies the dish information based on the nutrient amount and the nutrient excess or deficiency information of the user.

### BACKGROUND

1. Technical Field

The present invention relates to a nutrition management system and a nutrition management program.

2. Related Art

With the spread of the Internet and the like, posting of dish recipes on the WEB, acquisition of desired dish recipes by users using searching functions, and use of the dish recipes have routinely occurred. Further, calculation and display of nutrient amounts for each recipe have been proposed so that recipes can be selected to supplement excess or deficiency of nutrients or to have meals with good balance (JP-A-2006-139554).

However, even when the nutrient amounts of recipes can be comprehended, individual nutrient states may not be comprehended, and thus recipes proper for individuals may not be selected.

On the other hand, various services for analyzing nutritional balance of individual meals have been proposed. For example, there are services in which users input contents of meals or snacks between meals to terminals such as PCs or mobile phones and transmit the contents to service companies and the service companies perform nutrition analysis from the meal data and reply to customers with nutrition analysis results or transmit images of meals instead of meal contents. However, there are problems in that the transmission of the contents or the images of meals (snacks between meals) at every meal or every snack between meals is troublesome and it is difficult to continue the transmission.

For example, one of the reasons why such services have not spread despite the fact that balance of meals and excess or deficiency of nutrients are recognized to be important in order to build healthy bodies is that such services may not be continued but for simpler services since the influence of the excess or deficiency of nutrients is rarely felt immediately and is actually felt after disease symptom appears for the first time. Meanwhile, since pregnant women have thoughts of health of unborn children strongly as well as the pregnant women themselves, there is a tendency to particularly pay attention to nutrition states.

However, dietary guidance for pregnant women in the related art has not been given to people with no particular problem, for example, pregnant women in danger of certain diseases. Further, merely guidance of required nutrients or the like has been performed and guidance or advice tailored for individual nutrition states or pregnancy weeks has not been performed.

### SUMMARY

An advantage of to some aspects of the invention is to provide a nutrition management system and a nutrition management program capable of performing nutrition management of pregnant women tailored for pregnancy duration (for example, pregnancy weeks) and nutrition states of the pregnant women.

### Application Example 1

A nutrition management system according to this application example includes: a memory unit that stores nutrition analysis result information regarding a nutrition state of a user obtained by analyzing a specimen collected from the user, user information including pregnancy duration information of the user, and dish information including food ingredient information used in a dish; a user information calculation processing unit that performs a process of calculating a required nutrient amount of the user based on the user information and calculating nutrient excess or deficiency information of the user based on the required nutrient amount and the nutrition analysis result information of the user; a dish information search processing unit that searches for the dish information based on an instruction from the user; and a dish information calculation processing unit that calculates a nutrient amount acquirable from the dish of the dish information and supplies the dish information based on the nutrient amount and the nutrient excess or deficiency information of the user.

A nutrition management server according to this application example is a server that includes each of these units. A nutrition management program according to this application example is a program that causes a computer to function as each of these units. An information storage medium according to this application example is a computer-readable information storage medium that stores the program causing a computer to function as each of the foregoing units.

According to this application example, it is possible to provide the system capable of searching for dish information (recipe or the like) tailored for a nutrition state analyzed using a pregnancy duration (for example, pregnancy weeks) of a pregnant woman and blood-gathering or urine examination at the time of a periodic pregnant woman heath diagnosis.

### Application Example 2

In the nutrition management system according to the application example described above, the user information may include meal history information of the user, and the user information calculation processing unit may obtain nutrients acquirable from a meal history indicated by the meal history information of the user and calculate the nutrient excess or deficiency information of the user in addition to the nutrient.

According to this application example, it is possible to provide the system capable of searching for dish information (recipe or the like) further tailored for a recent heath state of the user by using the nutrient excess or deficiency information calculated from the nutrition analysis result and the meal history information.

### Application Example 3

In the nutrition management system according to the application example described above, the dish information search processing unit may perform evaluation by scoring the dish information, perform at least one of a process of adding a score when nutrients acquirable from the dish include a deficient nutrient of the user and a process of subtracting the score when the nutrients acquirable from the dish include an excessive nutrient of the user, and supply the dish information according to the score.

According to this application example, it is possible to properly perform ranking by scoring the dish information based on at least one of the deficient nutrient and the excessive nutrient. Further, by supplying the dish information according to the scores, it is possible to supply the dish information (recipe or the like) of the search result in a high order of the degree of recommendation according to the nutrition state and the pregnancy duration of the user (for example, to display the dish information on a user terminal).

### Application Example 4

In the nutrition management system according to the application example described above, the memory unit may store first recommendation information associating a length of a pregnancy duration of the user with at least one of a recommended nutrient, a recommended dish, and a recommended food ingredient, and the dish information search processing unit may obtain at least one of the recommended nutrient, the recommended dish, and the recommended food ingredient according to the length of the pregnancy duration of the user based on the first recommendation information and the pregnancy duration of the user and evaluate the searched dish information based on at least the one of the recommended nutrient, the recommended dish, and the recommended food ingredient.

The recommendation information may be recommendation information regarding the length of the pregnancy duration and a recommended dish or may be recommendation information regarding the length of the pregnancy duration and recommended food ingredients. The degree of recommendation may be set to be higher when a dish or the food ingredients contained in the dish contain nutrients which the user particularly eats during respective pregnancy weeks than when the dish or the food ingredients contained in the dish do not contain the nutrients.

According to this application example, it is possible to preferentially supply the user with the dish information including the recommended nutrients and recommended food ingredients according to the length of the pregnancy duration, or the dish information (recipe or the like) of the recommended dish according to the length of the pregnancy duration (for example, to display the dish information on the user terminal).

### Application Example 5

In the nutrition management system according to the application example described above, the first recommendation information may include information regarding at least one element among a nutrient, a dish, and a food ingredient which the user is allowed to particularly eat in correspondence with the pregnancy duration or regarding at least one element among a nutrient, a dish, and a food ingredient which the user is not allowed to eat, the user information calculation processing unit may obtain a recommended element which the user is allowed to particularly eat or a non-recommended element which the user is not allowed to eat based on the first recommendation information and the pregnancy duration of the user, and the dish information search processing unit may perform evaluation by scoring the dish information, perform at least one of a process of adding a score when elements acquirable from the dish include the recommended element and a process of subtracting the score when the elements include the non-recommended element, and supply the dish information according to the score.

According to this application example, it is possible to properly perform ranking by scoring the recommended element decided or the non-recommended element which the user is not allowed to eat according to the pregnancy duration of the user. By supplying the dish information (recipe or the like) according to the scores, it is possible to supply the dish information in a high order of the degree of recommendation according to the nutrition state and the pregnancy duration of the user (for example, to display the dish information on the user terminal).

### Application Example 6

In the nutrition management system according to the application example described above, the user information may include commonly used supplement information regarding a supplement (including nutritional supplement food) which the user eats periodically. The user information calculation processing unit may calculate the nutrient excess or deficiency information of the user in addition to a nutrient acquirable from the supplement indicated by the commonly used supplement information.

According to this application example, by adding information regarding supplements (including nutritional supplement food) commonly used by the user, it is possible to determine the nutrient excess or deficiency state of the user with higher accuracy, and it is possible to supply the dish information (recipe or the like) (for example, display the dish information on the user terminal).

### Application Example 7

In the nutrition management system according to the application example described above, the user information may include morning sickness information regarding a morning sickness state of the user, the memory unit may store second recommendation information associating the morning sickness state with a recommended dish or a recommended food ingredient, and the dish information searching unit may obtain the recommended dish or the recommended food ingredient according to the morning sickness state of the user based on the second recommendation information and the morning sickness information of the user and evaluate the searched dish information based on the obtained recommended dish or recommended food ingredient.

According to this application example, by adding the information regarding the morning sickness state of the user, it is possible to supply the dish information (recipe or the like) including effective nutrients or the like in accordance with the morning sickness state of the user (for example, display the dish information on the user terminal).

### Application Example 8

In the nutrition management system according to the application example described above, the user information may include personal information, the personal information may include attribute information regarding at least one of sex, weight, age, activity level of the user, and the user information calculation processing unit may calculate the required nutrient amount of the user based on at least the one of the sex, the weight, the age, and the activity level of the user and the pregnancy duration information of the user.

According to this application example, it is possible to calculate the required nutrient amount of the user according to the attribute information regarding at least one of the sex, weight, age, and activity level of the user and the pregnancy duration information.

### BRIEF DESCRIPTION OF THE DRAWINGS

The invention will be described with reference to the accompanying drawings, wherein like numbers reference like elements.

FIG. 1 is a diagram illustrating a network configuration of a nutrition management system according to an embodiment.

FIG. 2 is an exemplary functional block diagram illustrating a server according to the embodiment.

FIG. 3 is a diagram for describing an overview of a nutrition management system according to the embodiment.

FIG. 4 is a diagram illustrating an example of registration contents of a user information database.

FIG. 5 is a diagram illustrating an example of registration contents of recipe information of a recipe information database.

FIG. 6 is a diagram illustrating an example of registration contents of food constituent information.

FIG. 7 is a diagram illustrating an example of registration contents of required amount information.

FIG. 8 is a flowchart illustrating the flow of a user information registration process.

FIG. 9 is a flowchart illustrating the flow of a recipe information registration process.

FIGS. 10A and 10B are diagrams for describing a calculation example of nutrients which can be acquired from dishes.

FIG. 11 is a diagram illustrating a nutrition analysis result of a user.

FIGS. 12A and 12B are diagrams for describing a process of updating a nutrient excess or deficiency ratio of the user based on meal history information.

FIG. 13 is a flowchart illustrating the flow of a recipe searching process according to the embodiment.

FIG. 14 is a diagram for describing a specific example of scoring of each recipe.

FIG. 15 is a diagram illustrating specific examples of recipe score calculation methods.

FIG. 16 is a diagram illustrating a relation table of recommended nutrients and non-recommended nutrients corresponding to pregnancy durations and disease states.

### DESCRIPTION OF EXEMPLARY EMBODIMENTS

Hereinafter, preferred embodiments of the invention will be described in detail with reference to the drawings. The drawings to be used are illustrated to facilitate the description. The embodiments to be described do not inappropriately limit the contents of the invention described in the appended claims. All of the configurations described in the embodiments are not essential constituent requirements of the invention.

### 1. Configuration

### 1-1. Nutrition Management System

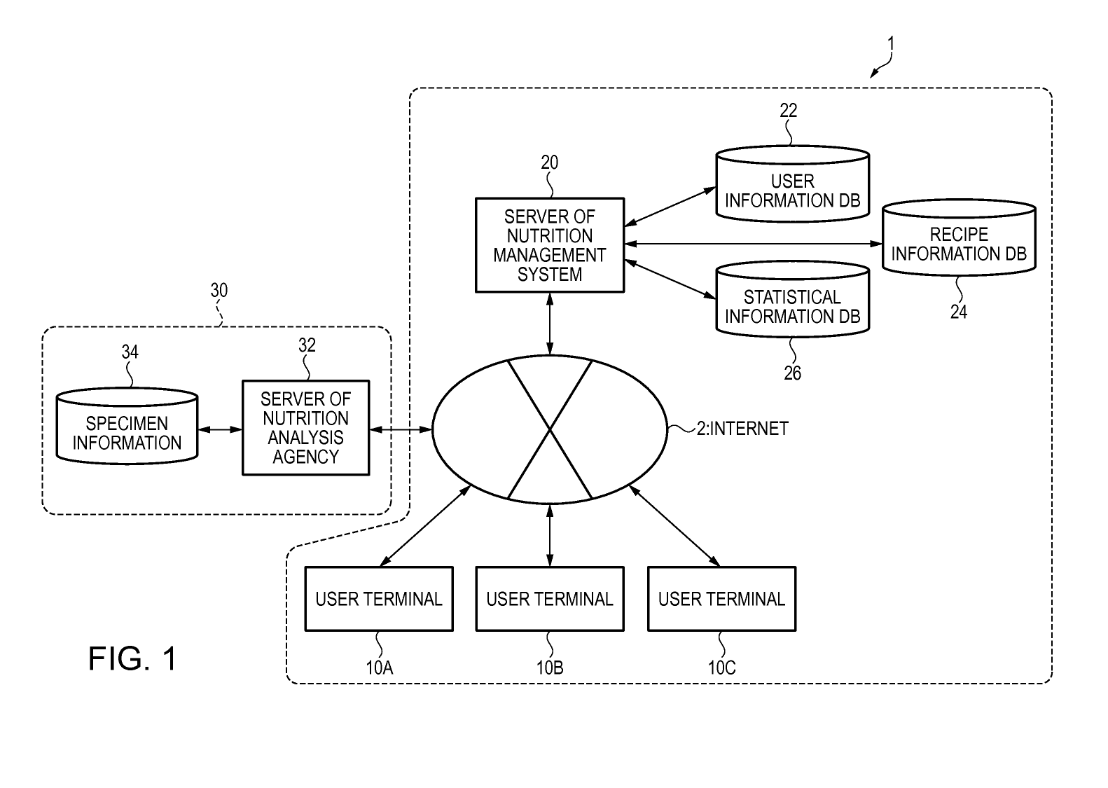

FIG. 1 is a diagram illustrating a network configuration of a nutrition management system 1 according to an embodiment. The nutrition management system 1 includes a server 20 of the nutrition management system supplying a service. The nutrition management system 1 can also be configured to include the server 20 of the nutrition management system and a plurality of user terminals 10A, 10B, etc. The user terminals 10A, 10B, etc. are, for example, smartphones, mobile phones, tablet terminals, personal computers, game terminals, or network home appliances. The server 20 of the nutrition management system is configured to be connected to the plurality of user terminals 10A, 10B, etc. via a communication network 2 such as the Internet and supplies recipe information (which is an example of dish information) to the user terminals 10A, 10B, etc. via the communication network 2.

The server 20 of the nutrition management system manages a user information database 22 storing user information, a recipe information database 24 storing recipe information, and a statistical information database 26 storing various kinds of statistical information.

The nutrition management system 1 according to the embodiment is configured to be connected to a server 32 of a nutrition analysis agency 30 via a communication network 2 such as the Internet. The nutrition management system 1 according to the embodiment may receive user specimen information retained by the server 32 of the nutrition analysis agency 30 via the communication network 2.

The users can use the user terminals 10A, 10B, and 10C to access a recipe supply site administrated by the server 20 of the nutrition management system. The users can search for recipes on the recipe supply site, and thus searched recipe information is transmitted to the user terminals 10A, 10B, and 10C to be displayed on display units.

### 1-2. Configuration of Server of Nutrition Management System

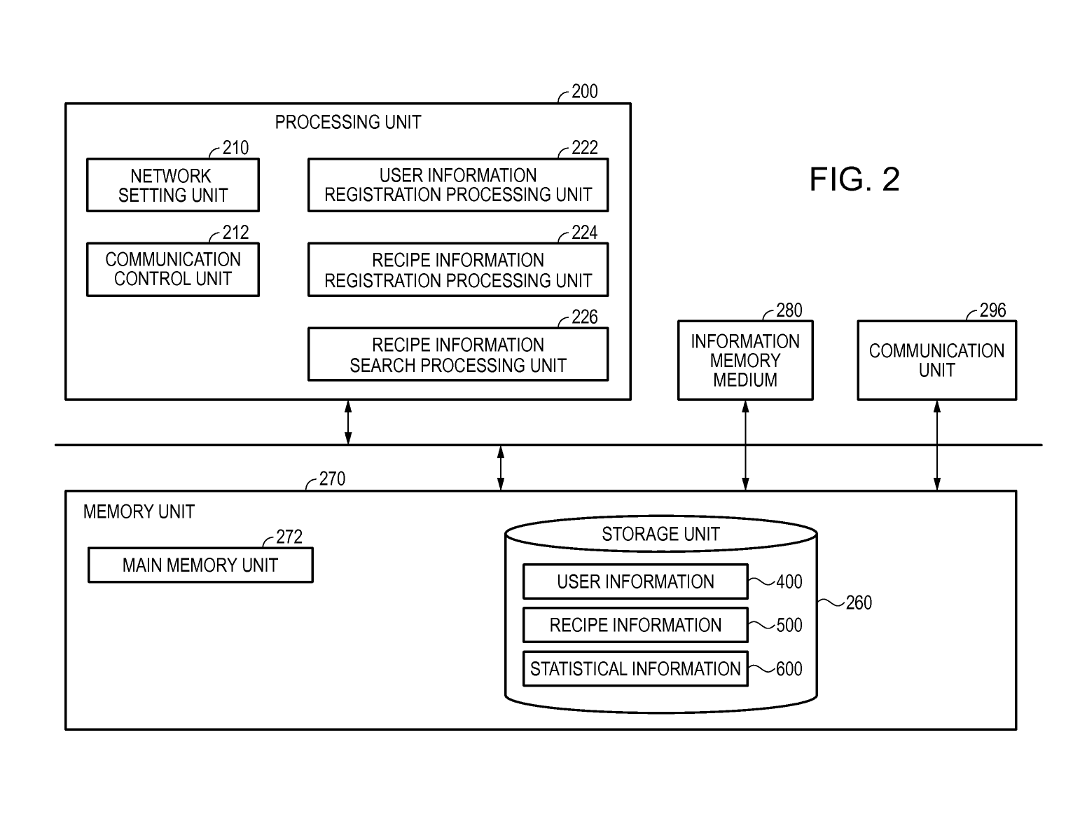

FIG. 2 is an exemplary functional block diagram illustrating the server 20 according to the embodiment. The server 20 according to the embodiment may be configured such that some of constituent elements (respective units) in FIG. 2 may be omitted.

The server 20 according to the embodiment includes a memory unit 270, a processing unit 200, a communication unit 296, and an information memory medium 280.

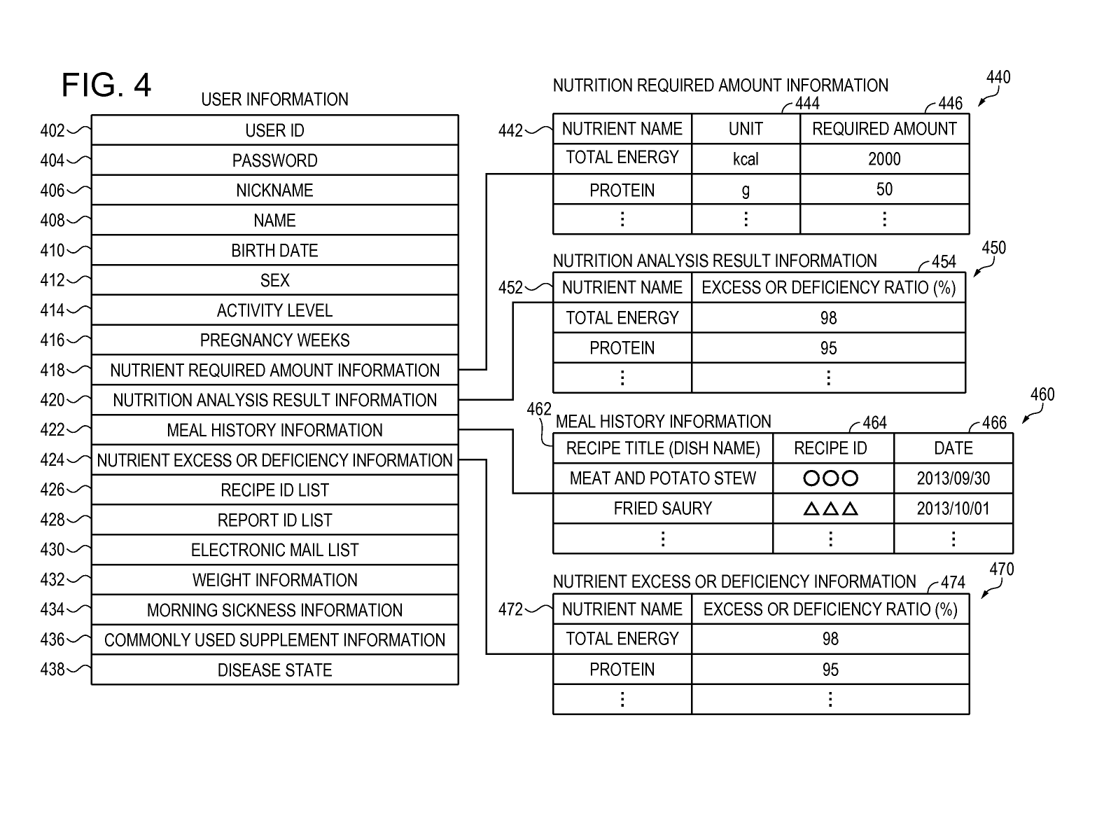

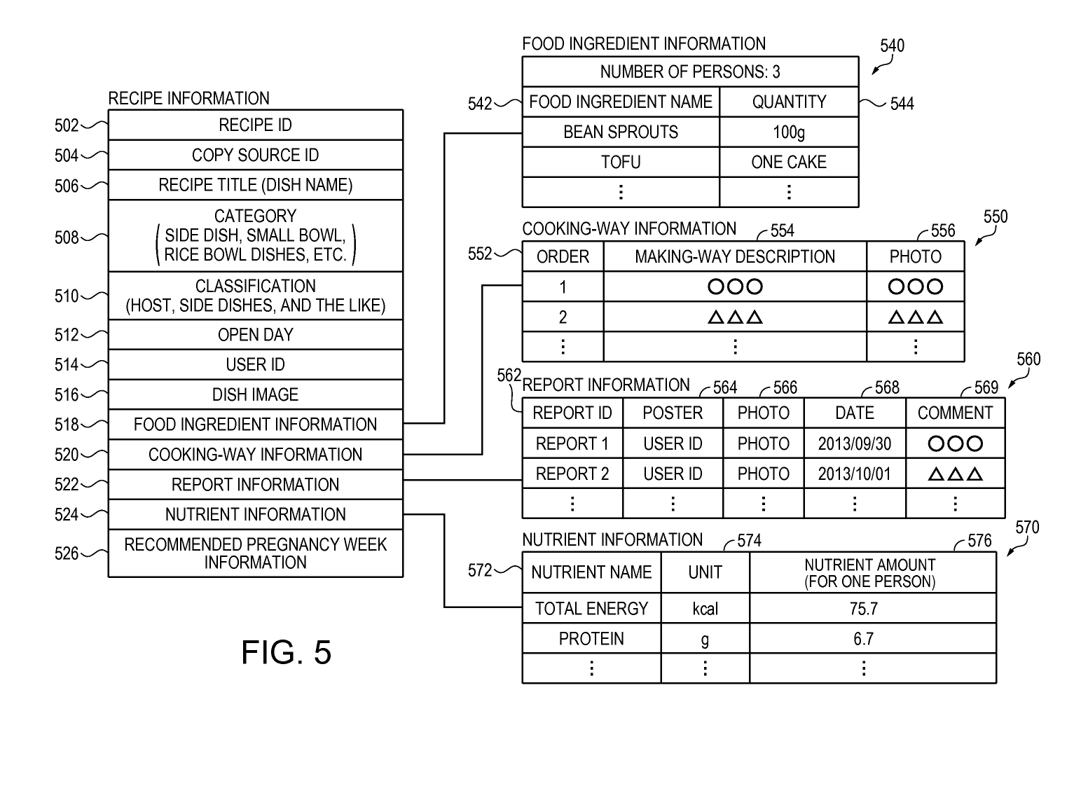

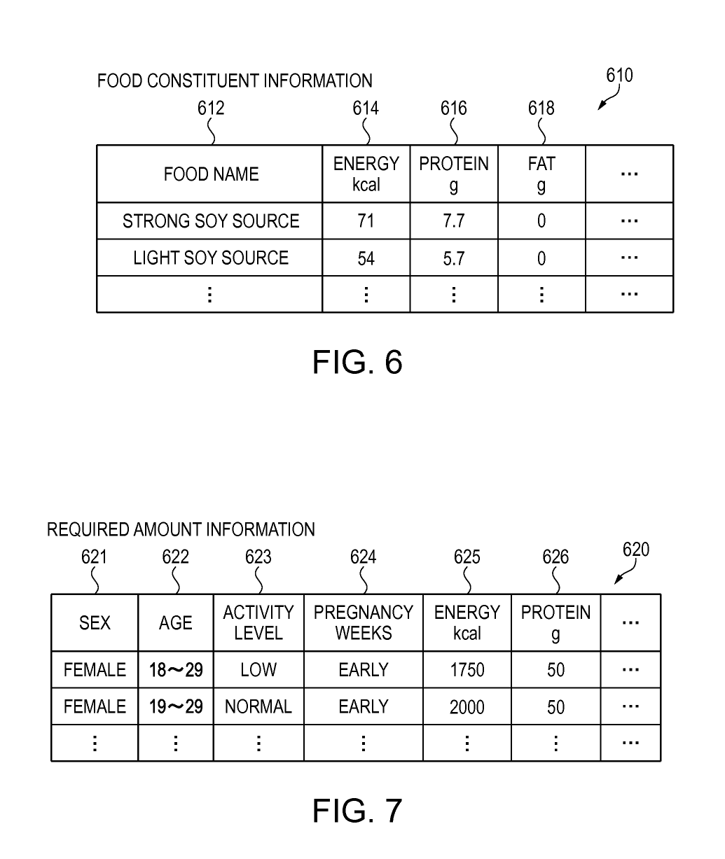

The memory unit 270 includes a storage unit 260 (for example, a database). The storage unit 260 stores user information 400 (see FIG. 4) and functions as user information database. The storage unit 260 stores recipe information 500 (which is an example of dish information: see FIG. 5) and functions as a recipe information database. The storage unit 260 stores statistical information 600 (see FIGS. 6 and 7) and functions as a statistical information database.

The user information 400 includes nutrition analysis result information regarding nutrition states of the users obtained by analyzing specimens collected from the users, personal information of the users, and pregnancy duration information of the users. The recipe information 500 includes food ingredient information used for dishes.

Statistical information (for example, statistical information regarding nutrient amounts necessary for ages, weights, and the like of the users) necessary to calculate required amounts of nutrients of the users based on the personal information and the pregnancy duration information may be stored as the statistical information 600. Statistical information (for example, statistical information regarding nutrient amounts included in the food ingredients) necessary to calculate dish nutrient information which can be acquired in the dishes based on the food ingredient information may be stored as the statistical information 600.

The information memory medium 280 (a computer-readable medium) stores a program, data, and the like.

The processing unit 200 performs various processes according to the embodiment based on the program (data) stored in the information memory medium 280. That is, the information memory medium 280 stores a nutrition analysis program (a program causing a computer to perform a process of each unit) causing a computer to function as each unit according to the embodiment.

The communication unit 296 performs various kinds of control to communicate with the outside (for example, a terminal or another server). The function can be realized by hardware such as various processors or a communication ASIC, a program, or the like.

The processing unit 200 (processor) performs a process based on the program or the like stored in the information memory medium 280. Specifically, a service is supplied in response to a request from a terminal. The function of the processing unit 200 is realized by hardware such as various processors (a CPU, a DSP, and the like), an ASIC (a gate array or the like) or a program.

The processing unit 200 includes a network setting unit 210, a communication control unit 212, a user information registration processing unit 222, a recipe information registration processing unit 224, and a recipe information search processing unit 226. Some of these units may be configured to be omitted.

The network setting unit 210 receives identification information of the user terminals 10A, 10B, etc. and stores network information of the user in the storage unit 260 in association with the received terminal identification information.

The communication control unit 212 performs a process of transmitting or receiving data to or from the server 32 of the specimen analysis agency or another computer such as the user terminal 10A, 10B, or 10C via the network.

Various processes in the user information registration processing unit 222, the recipe information registration processing unit 224, and the recipe information search processing unit 226 may be performed by the server 20 or all or some of the processes may be performed by the terminal.

The user information registration processing unit 222 functions as a user information calculation processing unit that performs a process of calculating required amounts of nutrients of the users based on the personal information and the pregnancy duration information of the users and calculating nutrient excess or deficiency information of the users based on the required amounts of nutrients and nutrition analysis result information of the users. The recipe information search processing unit 226 functions as a dish information search processing units that searches for recipe information (which is an example of dish information) based on an instruction from the users. The recipe information registration processing unit 224 functions as a dish information calculation processing unit that performs a process of calculating the amounts of nutrients which can be acquired from dishes based on the food ingredient information used for the dishes.

The recipe information search processing unit (dish information search processing unit) 226 evaluates searched dish information based on the amounts of nutrients which can be acquired in the dishes of the searched dish information and the nutrient excess or deficiency information of the user and supplies the dish information.

The pregnancy duration information may be information with which pregnancy weeks or months of the users can be determined or may be information regarding expected dates of delivery. Specimens collected from the users may be blood, urine, or the like of the users. The dish information may include food ingredient information included in dishes or information regarding cooking ways.

The storage unit 260 may store meal history information of the users as the user information 400. The user information registration processing unit (user information calculation processing unit) 222 may obtain nutrients which can be acquired based on meal histories indicated by the meal history information of the users and calculate the nutrient excess or deficiency information of the users in addition to the nutrients.

The recipe information search processing unit (dish information search processing unit) 226 may perform at least one of a process of scoring the evaluation of the dish information and adding the scores when the nutrients which can be acquired in the dishes include deficient nutrients of the users and a process of subtracting the scores when the nutrients which can be acquired in the dishes include excessive nutrients of the users and may supply dish information according to the scores.

The storage unit 260 may store, as the statistical information 600, first recommendation information associating the length of pregnancy duration with at least one of a recommended nutrient, a recommended dish, and a recommended food ingredient. The recipe information search processing unit (dish information search processing unit) 226 may obtain at least one of the recommended nutrients, the recommended dishes, and the recommended food ingredients according to the lengths of the pregnancy durations of the users based on the pregnancy durations of the users and the first recommendation information and may evaluate the searched dish information. The recommendation information may be recommendation information regarding the lengths of the pregnancy durations and the recommended dishes or may be recommendation information regarding the lengths of the pregnancy durations and the recommended food ingredients. The degree of recommendation may be set to be higher when dishes or the food ingredients contained in the dishes contain nutrients which the users are allowed to eat for each pregnancy week than when the dishes or the food ingredients do not contain the nutrients.

The first recommendation information may include information regarding at least one element among the nutrients, dishes, and food ingredients which the users are allowed to particularly eat or at least one element among the nutrients, dishes, and food ingredients which the users are not allowed to eat in correspondence with the pregnancy durations.

The user information registration processing unit (user information calculation processing unit) 222 may obtain recommended elements which the users have to eat or non-recommended elements which the users have to abstain from eating based on the first recommendation information and the pregnancy durations of the user.

The recipe information search processing unit (dish information search processing unit) 226 may perform at least one of a process of scoring the evaluation of the dish information and adding the scores when the elements which can be acquired in the dishes include the recommended elements and a process of subtracting the scores when the elements include the non-recommended elements and may supply (display) dish information according to the scores.

The storage unit 260 may store commonly used supplement information regarding supplements (including nutritional supplements) which the users eat periodically as the user information 400. The user information registration processing unit (user information calculation processing unit) 222 may calculate the nutrient excess or deficiency information of the user in addition to nutrients which can be acquired in the supplements indicated by the commonly used supplement information.

The storage unit 260 may store morning sickness information regarding morning sickness states of the users as the user information 400. The storage unit 260 may store second recommendation information associating the morning sickness states with the recommended dishes or the recommended food ingredients as the statistical information 600.

The recipe information search processing unit (dish information search processing unit) 226 may obtain recommended dishes or recommended food ingredients according to the morning sickness states of the users based on the second recommendation information and the morning sickness information of the users and may evaluate the searched dish information based on the obtained recommended dishes or recommended food ingredients.

The personal information of the users stored as the user information 400 in the storage unit 260 may include attribute information regarding at least one of the sex, the weight, the age, and the activity level of each user. The user information registration processing unit (user information calculation processing unit) 222 may calculate the required amounts of nutrients of each user based on at least one of the sex, the weight, the age, and the activity level of each user and the pregnancy duration information of each user.

### 2. Process of Embodiment

### 2-1. Overview of System

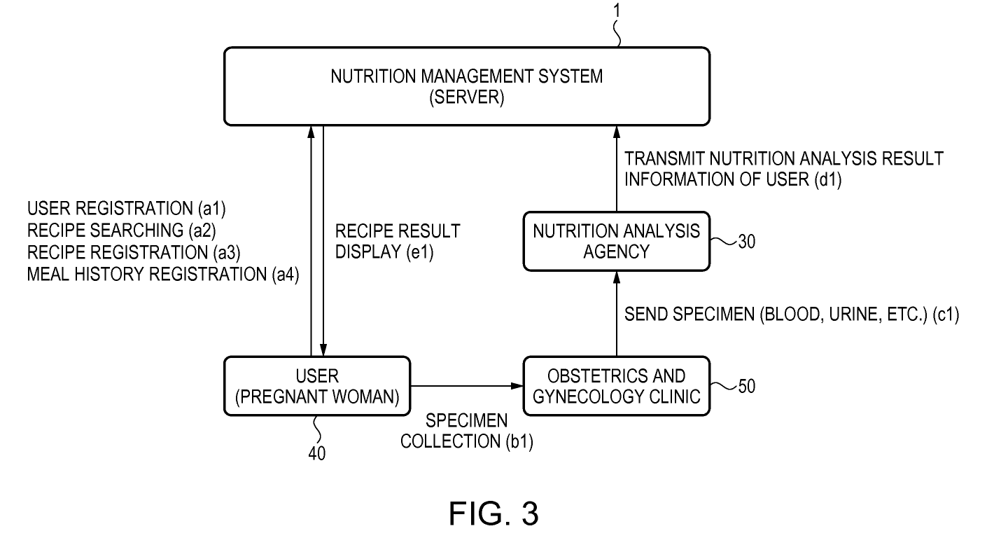

FIG. 3 is a diagram for describing an overview of the nutrition management system according to the embodiment. A user (pregnant woman) 40 performs user registration (a1) on a site administrated on the WEB by the nutrition management system 1 and starts using the system. A specimen such as urine or blood is collected (b1) when the user 40 is examined in a periodic pregnant woman diagnosis at an obstetrics and gynecology clinic 50 which the user 40 goes to, and the obstetrics and gynecology clinic 50 transmits the collected specimen to the nutrition analysis agency 30 (c1). The nutrition analysis agency 30 analyzes the specimen to analyze the health state of the user and transmits an analysis result of the nutrition state as nutrition analysis result information to the nutrition management system (d1). The nutrition management system 1 registers the received nutrition analysis result information of the user as user information.

The user 40 can access the site administrated on the WEB by the nutrition management system to perform recipe searching (a2), recipe registration (a3), and meal history registration (a3). When the user 40 performs the recipe searching, the nutrition management system 1 supplies a recipe proper for the nutrition state of the user 40.

### 2-2. User Information Database

FIG. 4 is a diagram illustrating an example of registration contents of the user information 400 of the user information database.

The user information 400 includes a user ID (which is an example of user identification information) 402, a password 404, a nickname 406, a name 408, a birth date 410, a sex 412, an activity level 414, pregnancy weeks (which are an example of the pregnancy duration and may be an expected date of delivery) 416, required nutrient amount information 418, nutrition analysis result information 420, meal history information 422, nutrient excess or deficiency information 424, a recipe ID list 426, a report ID list 428, an electronic mail address 430, weight information 432, morning sickness information 434, and commonly used supplement information 436.

The required nutrient amount information 418 may be configured as information including a nutrient name 442, a unit 444, and a required amount 446 of each nutrient necessary for the user, for example, as indicated by 440.

The nutrition analysis result information 420 may be configured as information including a nutrient name 452 and an excess or deficiency ratio 454 of each nutrient as the nutrition analysis result of each user, for example, as indicated by 450.

The meal history information 422 may be configured as information including a recipe title 462, a recipe ID 464, an eating date 466 corresponding to each meal content as the meal contents of each user, for example, as indicated by 460.

The nutrient excess or deficiency information 424 may be configured as information including a nutrient name 472 and an excess or deficiency ratio 474, for example, as indicated by 470.

### 2-3. Recipe Information Database

FIG. 5 is a diagram illustrating an example of registration contents of the recipe information 500 of the recipe information database.

The recipe information 500 includes a recipe ID 502, a copy source ID 504, a recipe title (dish name) 506, a category 508, classification 510, an open day 512, a user ID 514, a dish image 516, food ingredient information 518, cooking-way information 520, report information 522, nutrient information 524, and recommended pregnancy week information 626.

The food ingredient information 518 may be configured as information including a food ingredient name 542 and a quantity 544, for example, as indicated by 540.

The cooking-way information 520 may be configured as information including a cooking-way order 552, a cooking-way description 554, a cooking-way photo 556, for example, as indicated by 550.

The report information 522 may be configured as information including a report ID 562, a poster 564, a chef photo 566, a posting day 568, a comment 569, for example, as indicated by 560.

The nutrient information 524 may be configured as information including a nutrient name 572, a unit 574, and a nutrient amount (for one person) 576, for example, as indicated by 570.

The report information 522 is information generated when another user other than a user registering the recipe makes food with reference to the recipe and posts a comment such as a photo, a thought, or the like. In the embodiment, when the user posts the recipe and, for example, the user wants to change the recipe a little with reference to a certain recipe, the user can copy the original recipe, modify the recipe, and register the modified points newly. In this case, the recipe ID of the copy source is also registered as the copy source ID 504. Further, basic cook menus may be registered in advance in the system so that the user rarely makes an effort to post the recipe from the beginning.

The recommended pregnancy week information 526 is information (which may be a period of time or information regarding months of pregnancy) regarding pregnancy weeks proper for the recipe. The recommended pregnancy week information 526 may be registered when the user registers the recipe or may be set in the system. For example, when an “early period” is registered as the recommended pregnancy week information 526, the recipe becomes a recipe proper for an early pregnancy period (1 to 15 weeks). When the recipe information is displayed based on a recipe search result and the pregnancy weeks of the user is identical to (or is close to) the pregnancy weeks recommended by the recommended pregnancy week information during the recipe search, the recipe information may be preferentially displayed. Further, a recommendation mark or the like may be displayed in the recipe and the user may be notified that the recipe is highly recommended.

### 2-4. Statistical Information Database

The statistical information database stores food constituent information and required amount information as the statistical information 600.

FIG. 6 is a diagram illustrating an example of registration contents of food constituent information.

As the food constituent information 610, energy 614 of a criterion amount of each food and quantities (g) of protein 616, fat 618, and the like contained in each food are stored in association with a food name 612 of each food.

The food constituent information 610 may use, for example, values stated for each food ingredient in “Standard tables of food composition in Japan” of the homepage of Ministry of Education, Culture, Sports, Science and Technology.

FIG. 7 is a diagram illustrating an example of registration contents of the required amount information.

As the required amounts 620, necessary energy amount (kcal for one day) 625, protein (g) 626, and the like corresponding to the personal attributes (sex 621, age 622, activity level 623, and pregnancy weeks 624) are stored.

For example, the values of necessary food constituents (shown based on age, sex, activity amount, and pregnancy week information) posted on the homepage of the Ministry of Agriculture, Forestry and Fisheries may be used as the required amount information.

### 2-5. User Information Registration Process

The server of the system opens a recipe supply site on the WEB, and thus the user can access the recipe supply site via the user terminal to perform user registration or to be supplied with the recipe information.

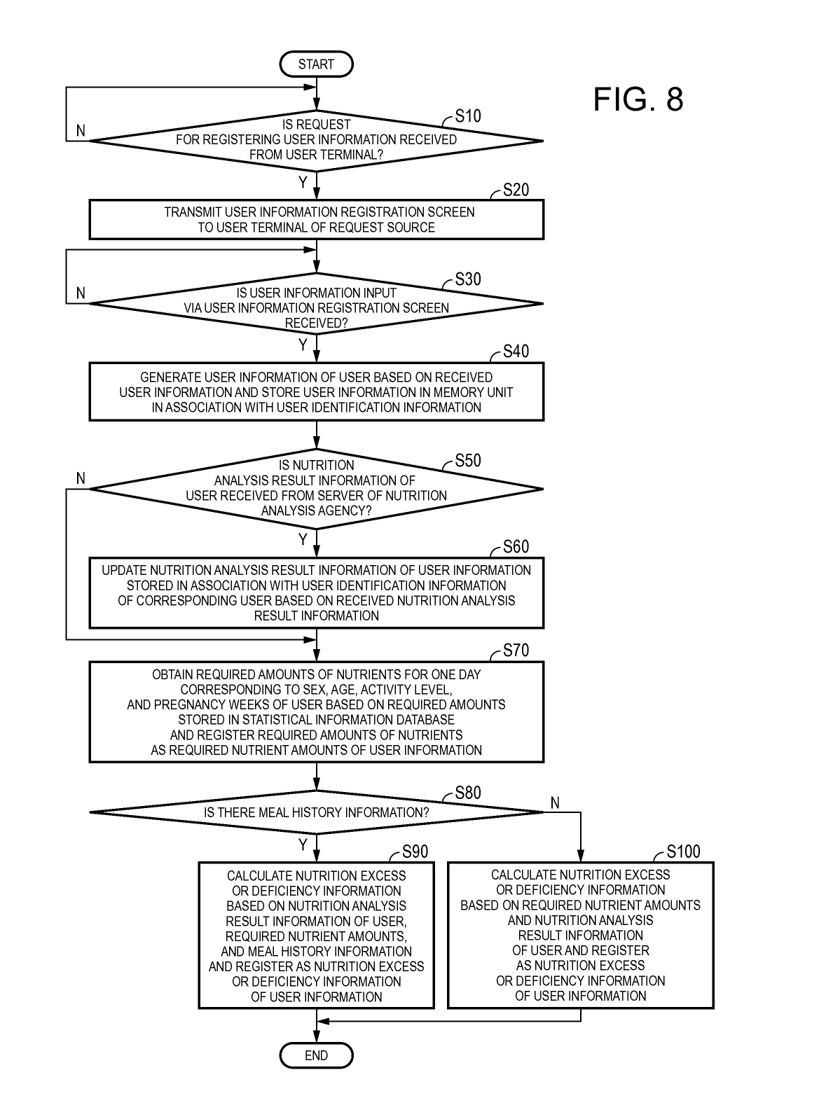

FIG. 8 is a flowchart illustrating the flow of a user information registration process.

When the server 1 of the system (the user information registration processing unit 222) receives a request for registering the user information from the user terminal 10 (Y in step S10), the server of the system transmits a user information registration screen to the user terminal 10 of the request source (step S20).

When the server 1 of the system receives user information input via the user information registration screen (Y in step S30), the server 1 of the system generates the user information 400 (see FIG. 4) of the user based on the received user information and stores the user information 400 in the memory unit 270 in association with the user ID (the user identification information) (step S40). For example, the password 404, the nickname 406, the name 408, the date 410, the sex 412, the activity level 414, the pregnancy weeks (which are an example of the pregnancy duration) 416, the meal history information 422, the recipe ID list 426, the report ID list 428, the electronic mail address 430, the weight information 432, the morning sickness information 434, and the commonly used supplement information 436 in FIG. 4 are the user information 400 stored in the memory unit 270 based on the user information received from the user terminal.

When the server 1 of the system (the user information registration processing unit 222) receives the nutrition analysis result information of the user from the server 32 of the nutrition analysis agency (Y in step S50), the server 1 of the system updates the nutrition analysis result information (see 420 and 450 in FIG. 4) of the user information 400 stored in association with the user ID (the user identification information) of the corresponding user based on the received nutrition analysis result information (step S60).

The server 1 of the system (the user information registration processing unit 222) obtains the required amounts of nutrients for one day corresponding to the sex, age, activity level, and pregnancy weeks of the user based on the required amounts stored in the statistical information database 26 and registers the required amounts of nutrients as required nutrient amounts of the user information (see 418 and 440 in FIG. 4) of the user information (step S70).

When the meal history information is registered as the user information 400 (Y in step S80), the server 1 of the system calculates the nutrient excess or deficiency information based on the nutrition analysis result information, the nutrition required amounts, and the meal history information of the user and registers the nutrient excess or deficiency information as the nutrient excess or deficiency information (see 424 and 470 in FIG. 4) of the user information 400 (step S90). When the meal history information is not registered as the user information 400 (N in step S80), the server 1 of the system calculates the nutrient excess or deficiency information based on the nutrition analysis result information and the required nutrient amounts of the user and registers the nutrient excess or deficiency information as the nutrient excess or deficiency information of the user information 400 (step S100).

### 2-6. Recipe Information Registration Process

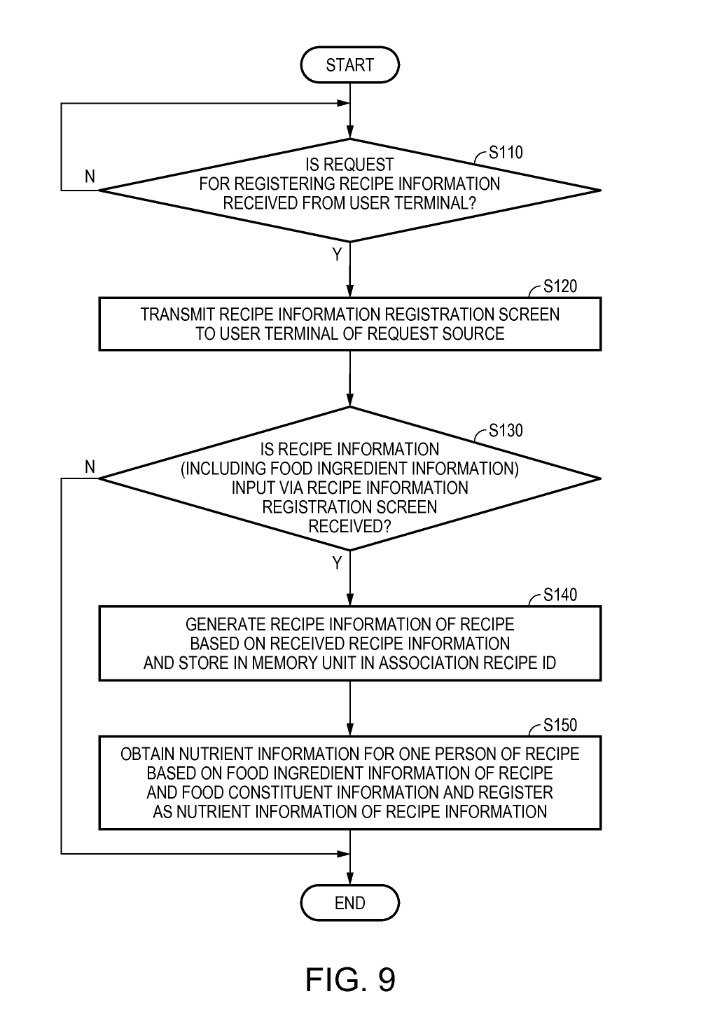

FIG. 9 is a flowchart illustrating the flow of a recipe information registration process.

In the server 1 of the system (the recipe information registration processing unit 224), information (see FIG. 5) regarding the recipe posted by the user is registered. Thereafter, the nutrient amounts corresponding to the quantity of each food ingredient are calculated based on the food ingredient information (518 and 540 in FIG. 5) and the food constituent information (see FIG. 6), the nutrient amounts of each recipe are calculated by summing the nutrient amounts of each food ingredient, the nutrient amounts of each recipe for one person are calculated by dividing the nutrient amounts by the target number of persons, and the calculated result is registered as the nutrient information (see 524 and 570 in FIG. 5) in the recipe information database.

When the server 1 of the system (the recipe information registration processing unit 224) receives a request for registering the recipe information from the user terminal 10 (Y in step S110), the server 1 of the system transmits a recipe information registration screen to the user terminal 10 of the request source (step S120).

When the server 1 of the system (the recipe information registration processing unit 224) receives the recipe information input via the recipe information registration screen (Yin step S130), the server 1 of the system generates the recipe information 500 (see FIG. 5) of the recipe based on the received recipe information and stores the recipe information 500 in the memory unit in association with the recipe ID (step S140). In regard to the recipe information 500, for example, the recipe ID 502, the copy source ID 504, the recipe title (dish name) 506, the category 508, the classification 510, the open day 512, the user ID 514, the dish image 516, the food ingredient information 518, the cooking-way information 520, the report information 522, and the recommended pregnancy week information 626 are stored as the recipe information 500 in the memory unit 270 based on the recipe information received from the user terminal 10.

The server 1 of the system (the recipe information registration processing unit 224) obtains the nutrient information (524 and 570 in FIG. 5) for one person of the recipe based on the food ingredient information and the food constituent information (see FIG. 6) of the recipe and registers the nutrient information as the nutrient information of the recipe information (step S150).

### 2-7. Process of Calculating Nutrient Information Acquirable in Dishes

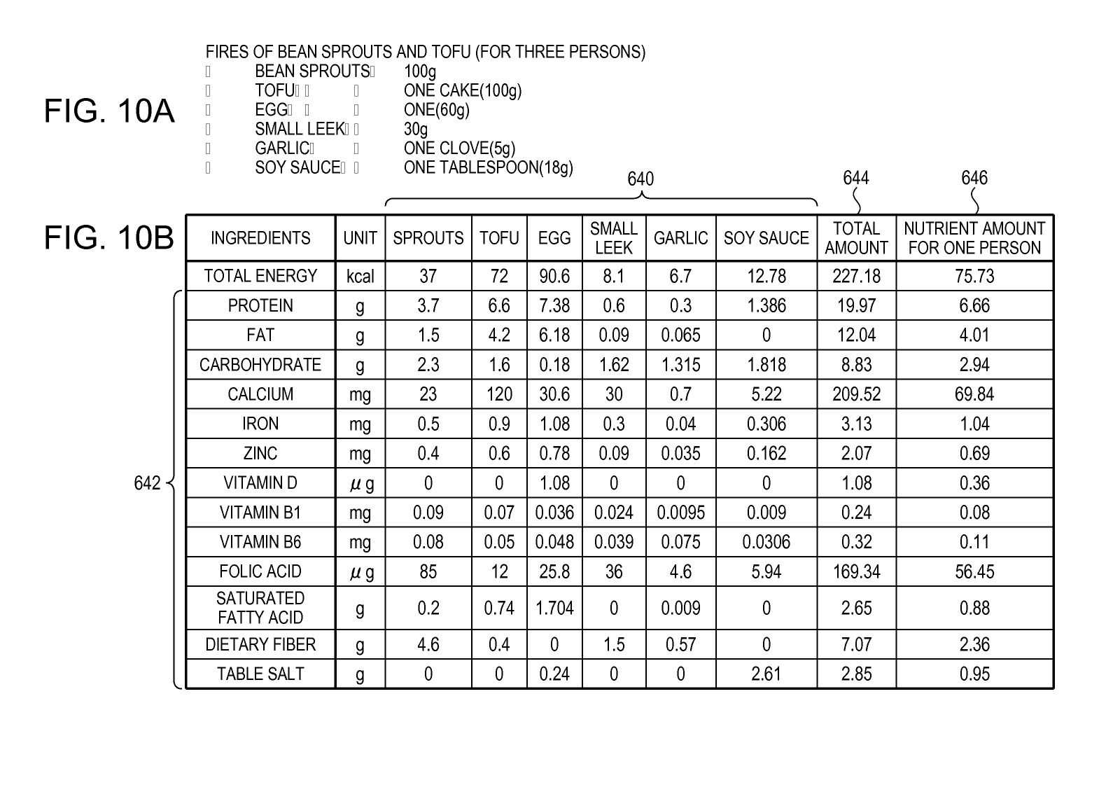

FIGS. 10A and 10B are diagrams for describing a calculation example of nutrients which can be acquired from dishes.

FIG. 10A illustrates the food ingredient information for three persons in regard to “fries of bean sprouts and tofu.” FIG. 10B illustrates items of the nutrients 642 included in each food ingredient (bean sprouts, tofu, etc.) 640 used in “fries of bean sprouts and tofu.” In this example, the description will be made focusing on several nutrients. First, content of each nutrient (for example, protein, fat, carbohydrate, calcium, etc.) 642 is calculated for each of the food ingredients 640 such as the bean sprouts and tofu used in “fries of bean sprouts and tofu” based on the food constitute information (see FIG. 6) and the quantities to be used. For example, as illustrated in FIG. 10B, 100 g of “bean sprouts” contains 3.7 g of protein and 1.5 g of fat. Then, all of the values of the food ingredients 640 are added to obtain total amounts 644 of the respective nutrients 642 and nutrient amounts 646 of the recipe for one person are calculated by dividing the total amounts by 3 which is the target number of persons of the recipe.

### 2-8. Process of Calculating Nutrient Excess or Deficiency Information

Next, a specific example of a process of calculating the nutrient excess or deficiency information will be described. When the user newly registers the meal history information on the user information registration screen, the system updates the meal history information (422 in FIG. 4) of the corresponding user of the user information database. When the nutrition analysis agency registers the nutrition analysis result information or when the nutrition analysis agency attains new nutrition analysis result information, the system updates the nutrition analysis result information (420 in FIG. 4) of the corresponding user of the user information database.

The system performs the process of calculating the nutrient excess or deficiency information when the meal history information is updated or the nutrition analysis result information is updated.

The nutrient excess or deficiency information is calculated based on the nutrition analysis result information (420 in FIG. 4) of the user, the meal history information (422 in FIG. 4) of the user, the food ingredient information (518 in FIG. 5) of the dish, and the statistical information (see FIGS. 6 and 7). An example of the calculation is as follows.

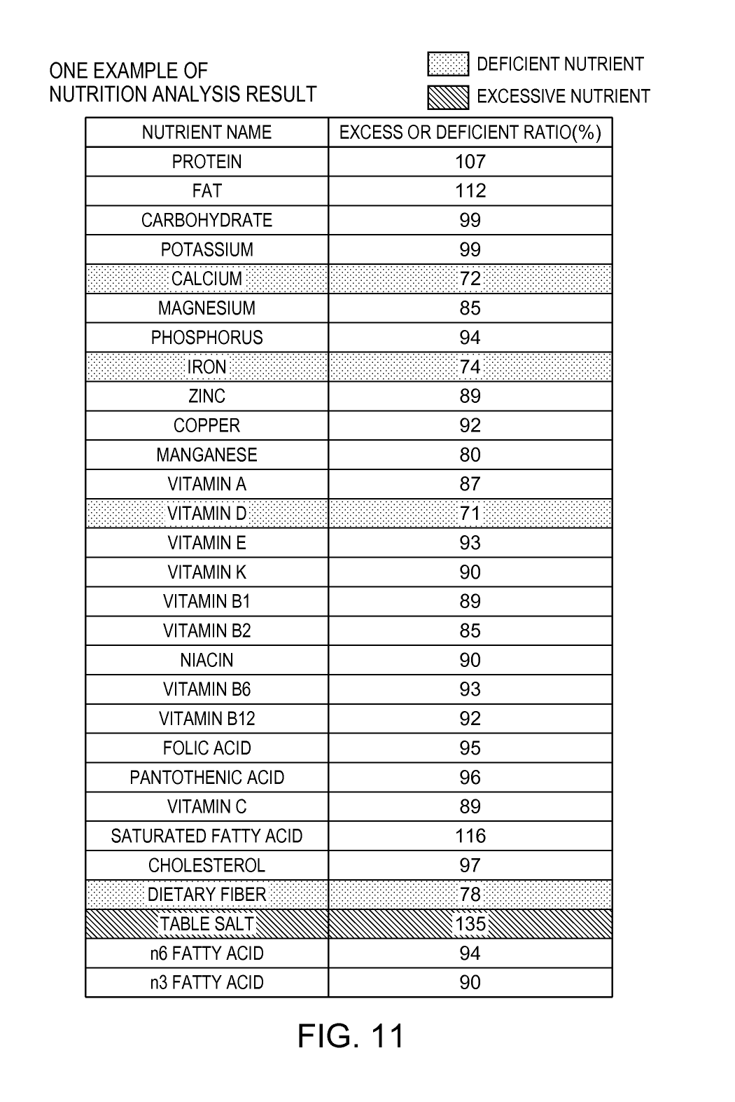

For example, the user is assumed to be female and 28-year-old, the activity level is normal (attribute information), and the pregnancy weeks are 5 weeks. The system can comprehend such information based on the user information. The nutrition analysis result (the nutrition analysis result information 420 in FIG. 4) of the user is assumed to be the contents illustrated in FIG. 11. The system can comprehend such information based on the user information 400.

The system determines deficient nutrients and excessive nutrients of the users according to the excess or deficiency ratios of the respective nutrients. For example, when nutrients with the excess or deficiency ratio less than 80% are assumed to be deficient nutrients and nutrients with the excess or deficiency ratio equal to or greater than 120% are excessive nutrients, as illustrated in FIG. 11, the deficient nutrients are calcium, iron, vitamin D, and dietary fiber and the excessive nutrient is table salt.

The system performs a process of updating the nutrient excess or deficiency ratios obtained as the nutrition analysis result information based on the meal contents (meals) registered in the meal history. More specifically, nutrient sufficiency ratios of the meal contents (meals) registered in the meal history are obtained and the nutrient excess or deficiency ratios of the user are accordingly updated.

For example, “fries of bean sprouts and tofu” is assumed to be registered as the meal history. The system searches for the recipe information 500 corresponding to the recipe ID (464 in FIG. 4) regarding “fries of bean sprouts and tofu,” acquires the food ingredient information (518 and 540 in FIG. 5) of “fries of bean sprouts and tofu,” calculates the nutrient amounts which can be acquired from “fries of bean sprouts and tofu” according to the method described in “2-7. Process of Calculating Nutrient Information Acquirable in Dishes,” and updates the nutrient excess or deficiency ratios of the user considering the users to acquire the nutrient amounts.

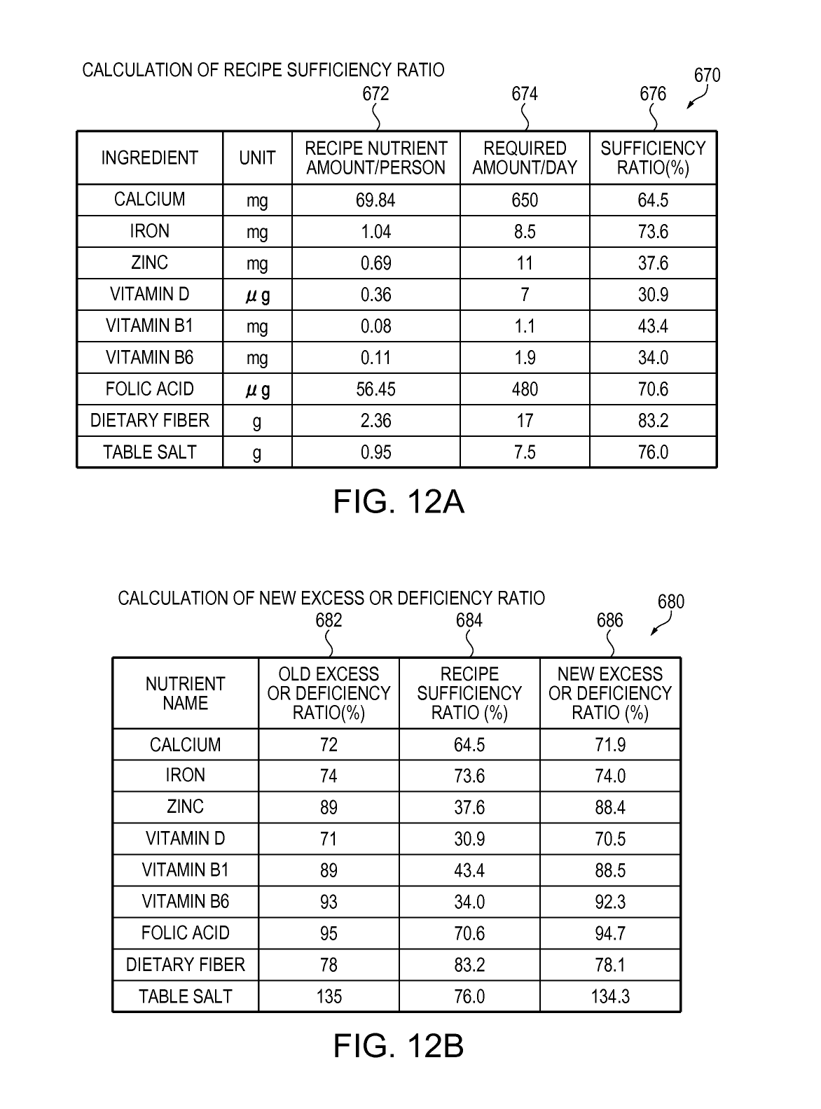

A process of updating the nutrient excess or deficiency ratios of the users based on the meal history information will be described with reference to FIGS. 12A and 12B.

FIG. 12A illustrates nutrient information of “fries of bean sprouts and tofu.” The data are narrowed down to the deficient nutrients, the excessive nutrients, and other several nutrients. A nutrient amount 672 is a recipe nutrient amount (646 in FIG. 10) which can be acquired with “fries of bean sprouts and tofu.” A required amount 674 is a value calculated from the required amount information (the statistical information: see FIG. 7) based on the attribute information of the user (female, 28 year-old, and normal activity level) the pregnancy weeks (5 weeks) of the user. The system calculates the recipe nutrient amount (A) 672 and the required amount (B) 674 and calculates a sufficiency ratio (C) 676 based on the recipe nutrient amount (A) 672 and the required amount (B) 674.

Recipe sufficiency ratio(C)=recipe nutrient amount(A)/(required amount(B)×α)×100 Expression (1)

Here, α may be obtained as follows, for example. The user is assumed to eat 3 times in a day and α for one meal satisfies α=1/3×α′. Further, since an amount differs according to classification of dish (510 in FIG. 5), α′=1/2 is set in the case of a main meal, α′=1/4 is set in the case of a side meal, and α′=1/4 is set in other cases. Since the fries of bean sprouts and tofu is a main dish, “α=1/3×1/2=1/6” is satisfied. In FIG. 12A, reference numeral 674 indicates the sufficiency ratio obtained according to Expression (1).

Next, a method of calculating a new excess or deficiency ratio (%) 686 to which the meal history is reflected will be described with reference to FIG. 12B. Reference numeral 682 indicates an old excess or deficiency ratio (E) before the meal history of “fries of bean sprouts and tofu” is reflected. The old excess or deficiency ratio (E) is an excess or deficiency ratio indicated by the nutrition analysis result information (see FIG. 11) when the meal history is not reflected. Reference numeral 684 is the above-described recipe sufficiency ratio (676 in FIG. 12A). The new excess or deficiency ratio (%) (D) 686 to which the meal history is reflected may be calculated as follows.

New excess or deficiency ratio(D)=old excess or deficiency ratio(E)×(1−β)+recipe sufficiency ratio(C)×β Expression (2)

Here, β may be obtained as follows, for example. Since a meal state for about 2 weeks is assumed to be reflected to a nutrient excess or deficiency state, 1/14 is applied for meals of one day among the meals of 2 weeks, and 1/3 is applied for one meal due to 3 meals per day, “β=1/14×1/3×β′” is satisfied. Further, since an amount of dish differs according to the classification (510 in FIG. 5) of dishes, “β=1/2” is set in the case of a main dish, “β=1/4” is set in the case of a side dish, and “β=1/4” is set in other cases. Accordingly, since the fries of bean sprouts and tofu is a main dish, “β=1/14×1/3×1/2” is equal to 1/84. Reference numeral 686 in FIG. 12B indicates a new nutrient excess or deficiency ratio obtained according to Expression (2). Updating of the excess or deficiency ratios of the nutrients according to the meal history can be performed in this way.

In registration of the meal history information, when a recipe is already registered as the recipe information 500 in a database, a meal history button may be displayed on the user terminal 10 along with the recipe information. When the user clicks the meal history button, the recipe may be registered as the meal history information along with a date. When a recipe has not been registered in the recipe information database, a recipe registration screen may be displayed on the user terminal 10 and the recipe registered by the user may be registered as the meal history information. Further, when a modification recipe registration button is displayed on the user terminal 10 along with the recipe information so that a recipe modification example in which ingredients or quantities are modified in a known recipe can simply be registered and the user clicks the modification recipe registration button, an edit screen of food ingredient information or the like of the recipe may be displayed, a user's modification input may be received, and modified contents may be registered as a modified recipe. For example, an interface on which the user can cope and modify an original recipe and can post the modified recipe to perform meal history registration with the user terminal may be supplied.

A system supply side may register food ingredient information of basic dish menus, dining-out menus of family restaurants or the like, goods sold in convenient stores or the like, instant food, cookies, supplements, nutritional supplement food, and the like in advance in the recipe information database. By doing so, the users may not necessarily make efforts and times for posting from the beginning and can accurately record nutrients which the users eat in meals.

Nutritional supplement food such as supplements eaten periodically may be registered on the user information registration screen of the user terminal by the user. When the commonly used supplement information (436 in FIG. 4) is registered in advance, a process of obtaining the sufficient ratios of the nutrients acquirable from the supplements and updating the excess or deficiency ratios as in the case of dishes may be performed.

A correction condition (a correction function or a weighted value used for correction) or the like of the excess or deficiency ratio may be prepared according to the kind of commonly used supplement and the excess or deficiency ratio may be corrected using the correction condition corresponding to the commonly used supplement.

### 2-9. Recipe Searching Process

In the system, the user can search for a recipe registered in the recipe information database of the system and refer to the recipe with the user terminal 10 by accessing a recipe search site of the system and inputting a keyword (a recipe name, a dish name, a food ingredient name, a nutrient name, or the like).

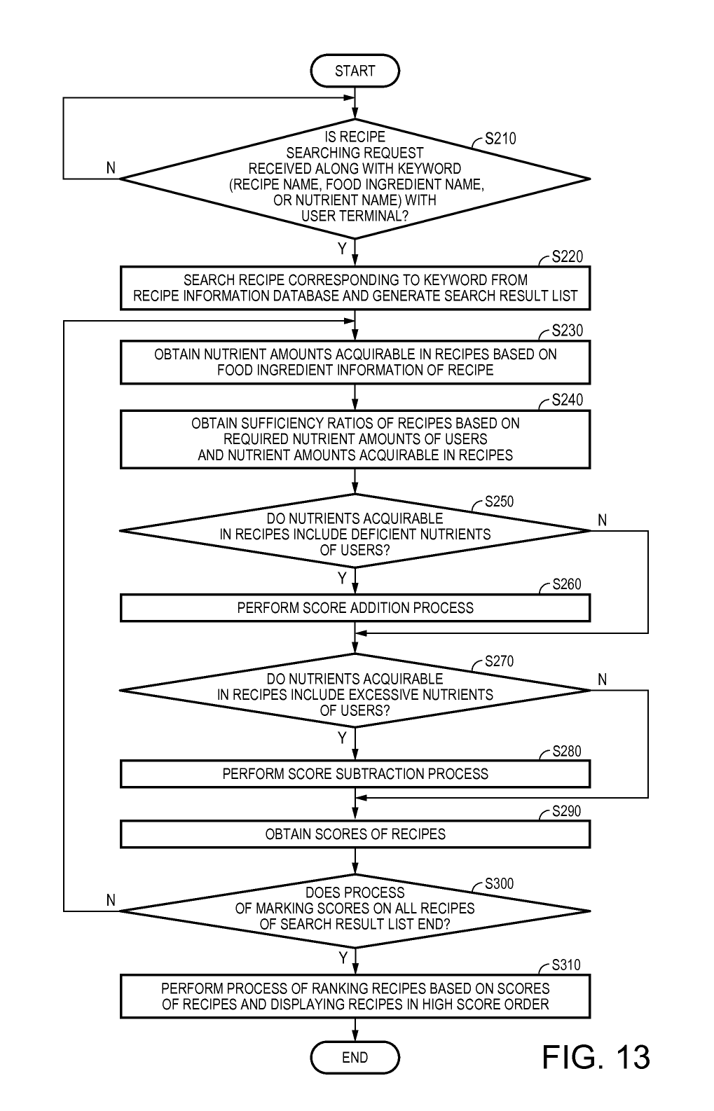

FIG. 13 is a flowchart illustrating the flow of a recipe searching process according to the embodiment.

When a recipe searching request is received along with the keyword (a recipe name, a food ingredient name, or a nutrient name) with the user terminal 10, the following processes are performed (step S210).

First, the user searches for a recipe corresponding to the keyword from the recipe information database and generates a search result list (step S220). For example, when the user inputs “tofu” as the keyword, L1, L2, L3, L4, and L5 are assumed to be hit as recipes containing tofu as a food ingredient. In this case, a search result list including the recipes L1, L2, L3, L4, and L5 is generated.

Next, the following processes are performed on all of the recipes (L1, L2, L3, L4, and L5) of the search result list. First, the nutrient amounts acquirable in the recipes are obtained based on the food ingredient information (518 in FIG. 5) of the recipes (step S230). The nutrient amounts obtained by performing “2-7. Process of Calculating Nutrient Information Acquirable in Dishes” at the time of a recipe information registration process and registering the calculated nutrient information as the nutrient information (524 and 570 in FIG. 5) of the recipe information can be used as the nutrient amounts acquirable in the recipes.

Then, the sufficiency ratios of the recipes are obtained based on the required nutrient amounts of the users and the nutrient amounts acquirable in the recipes (step S240). Based on the required nutrient amounts of the users and the nutrient amounts acquirable in the recipes, the sufficiency ratios of the recipes can be obtained according to the method (for example, Expression (1)) described in “2-8. Process of Calculating Nutrient Excess or Deficiency Information.”

When the nutrients acquirable in the recipes include deficient nutrients of the users (Y in step S250), the process of adding the scores is performed (step S260). When the nutrients acquirable in the recipes include excessive nutrients of the users (Y in step S270), the process of subtracting the scores is performed (step S280). Then, the scores of the recipes obtained by totaling the scores are obtained (step S290).

The processes of steps S230 to S290 are repeated until the process of marking the scores on all of the recipes of the search result list ends. When the process of marking the scores on all of the recipes of the search result list ends (Y in step S300), a process of ranking the recipes based on the scores of the recipes and displaying the recipes in a high score order is performed (step S310). For example, when the score of the recipe L1 is 12 points, the score of the recipe L2 is 10 points, the score of the recipe L3 is −5 points, the score of the recipe L4 is 4 points, and the score of the recipe L5 is 15 points, the ranking of the recipes with the scores is L5>L1>L2>L4>L3. Accordingly, the order of L5>L1>L2>L4>L3 may be displayed as the search result of the recipes. When the list of the recipes is displayed, L5>L1>L2>L4>L3 may be displayed. The recipes may be ranked in the order of L5>L1>L2>L4>L3 and the user may sort the recipe list at the ranks.

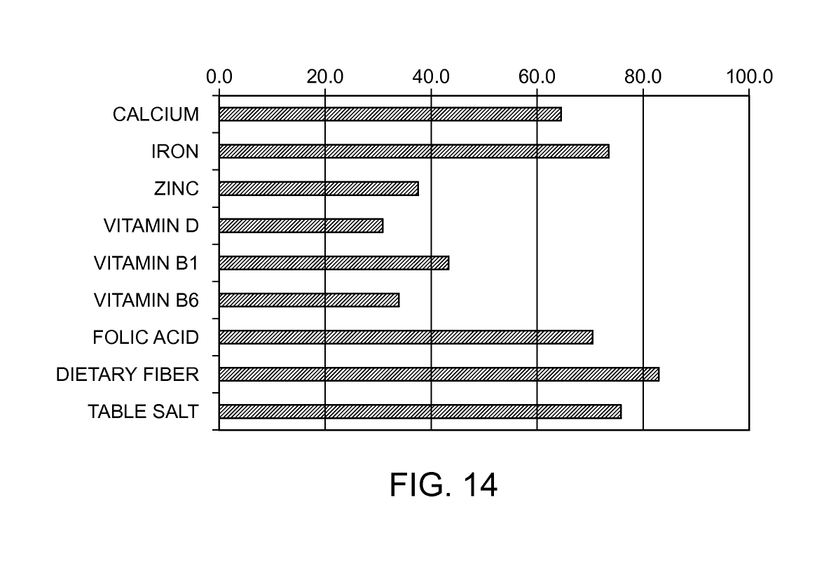

A specific example of the scoring of the recipes will be described with reference to FIG. 14. The user during the recipe search is assumed to be female and 28-year-old and the activity level (attribute information) is assumed to be normal, and the pregnancy weeks are assumed to be 5 weeks. The system is assumed to be able to comprehend such information based on the user information and the nutrition analysis result (the nutrition analysis result information 420 in FIG. 4) of the user is assumed to have the contents illustrated in FIG. 11.

FIG. 14 is a graph illustrating the sufficiency ratios of the recipe of “fries of bean sprouts and tofu” in regard to the user having the nutrition analysis result illustrated in FIG. 11. The sufficiency ratios of the recipe can be obtained according to the method (for example, Expression (1)) described in “2-8. Process of Calculating Nutrient Excess or Deficiency Information.”

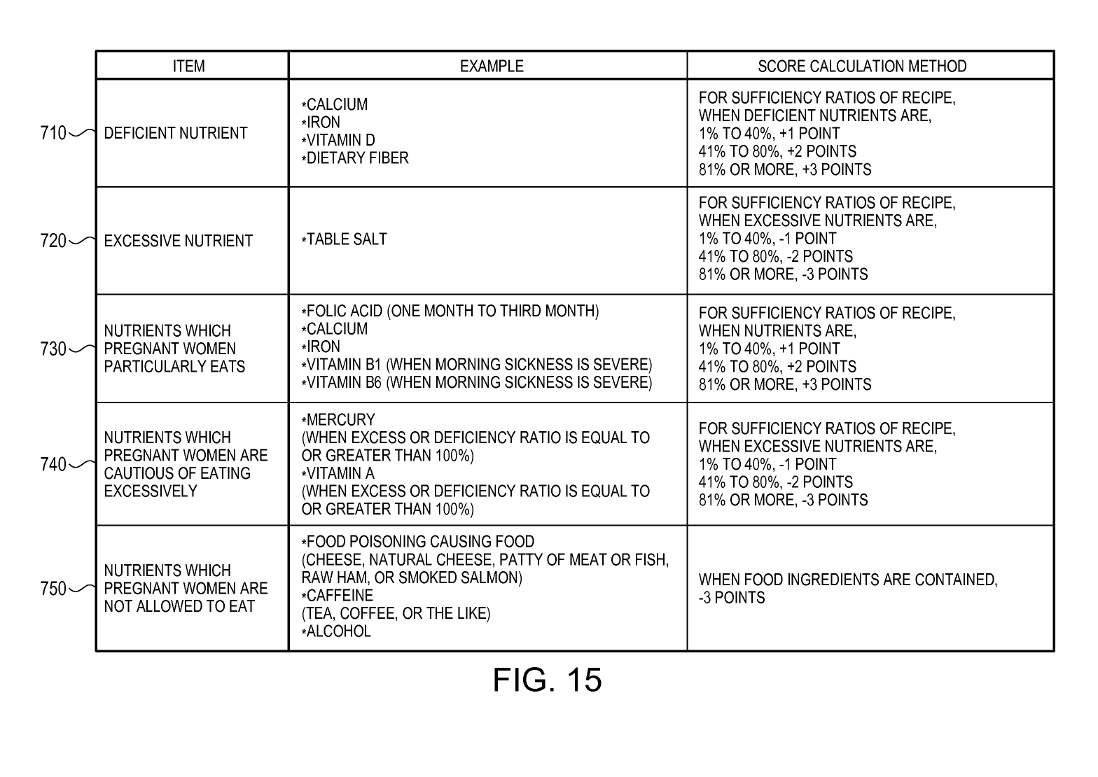

FIG. 15 is a diagram illustrating specific examples of recipe score calculation methods.

In FIG. 15, reference numeral 710 indicates the contents of a score addition process on deficient nutrients (for example, “calcium,” “iron,” “vitamin D,” and “dietary fiber”) of the user during the recipe search and indicates a relation between the sufficient ratios and the added stores of the recipe (for example, “fries of bean sprouts and tofu”). When 1% to 40% of the deficient nutrients are contained in the recipe, a score of +1 is added. When 41% to 80% of the deficient nutrients are contained in the recipe, a score of +2 is added. When 81% or more of the deficient nutrients are contained in the recipe, a score of +3 is added.

In FIG. 15, reference numeral 720 indicates the contents of a score subtraction process on an excessive nutrient (for example, “table salt”) of the user during the recipe search and indicates a relation between the sufficient ratios and the subtracted scores of the recipe (for example, “fries of bean sprouts and tofu”). When 1% to 40% of the excessive nutrient is contained in the recipe, a score of −1 is added. When 41% to 80% of the excessive nutrients is contained in the recipe, a score of −2 is added. When 81% or more of the excessive nutrients is contained in the recipe, a score of −3 is added.

In FIG. 15, reference numeral 730 indicates the contents of a score addition process on nutrients particularly necessary for pregnant women and indicates a relation between the sufficiency ratios and the added scores of the recipe (for example, “fries of bean sprouts and tofu”) of the nutrients (for example, “folic acid” (one month before to third month), “calcium,” “iron,” “vitamin B1,” (when morning sickness is severe), and “vitamin B6” (when morning sickness is severe, “table salt”)) particularly necessary for pregnant women. When 1% to 40% of the nutrients particularly necessary for pregnant women are contained in the recipe, a score of +1 is added. When 41% to 80% of the nutrients are contained in the recipe, a score of +2 is added. When 81% or more of the nutrients are contained in the recipe, a score of +3 is added.

In FIG. 15, reference numeral 740 indicates the contents of a score subtraction process on nutrients which pregnant women are cautious of eating excessively and a relation between the sufficiency ratios and the subtracted scores of the recipe (for example, “fries of bean sprouts and tofu”) of the nutrients (for example, “mercury” (when the excess or deficiency ratio is equal to or greater 100%) and “vitamin A” (when the excess or deficiency ratio is equal to or greater 100%)) which the pregnant women are cautious of eating excessively. When 1% to 40% of the nutrients which the pregnant women are cautious of eating excessively are contained in the recipe, a score of −1 is added. When 41% to 80% of the nutrients are contained in the recipe, a score of −2 is added. When 81% or more of the nutrients are contained in the recipe, a score of −3 is added.

In FIG. 15, reference numeral 750 indicates the contents of a score subtraction process on food ingredient constituents which the pregnant women are not allowed to eat. When a food ingredient constituent (food poisoning causing food (cheese, natural cheese, patty of meat or fish, raw ham, or smoked salmon), caffeine (tea, coffee, or the like), or alcohol) which the pregnant women are not allowed to eat is included, a score subtraction process of −3 points is performed.

As described in “2-8. Process of Calculating Nutrient Excess or Deficiency Information,” when the deficient nutrients and the excessive nutrients of the user are determined, the nutrients with the excess or deficiency ratios (see FIG. 11) less than 80% are assumed to be deficient nutrients, and the nutrients with the excess or deficiency ratios equal to or greater than 120% are assumed to be excessive nutrients, deficient nutrients of the user during the recipe search are “calcium,” “iron,” “vitamin D,” and “dietary fiber” and the excessive nutrient is “table salt.”

Referring to FIG. 14, since the sufficiency ratio of “calcium,” which is a deficient nutrient, in “fries of bean sprouts and tofu” is in the range of 41% to 80%, +2 points are added. Since the sufficiency ratio of “iron” is in the range of 41% to 80%, +2 points are added. Since the sufficiency ratio of “vitamin D” is in the range of 1% to 40%, +1 point is added. Since the sufficiency ratio of “dietary fiber” is equal to or greater than 81%, +3 points are added.

When the sufficient ratio of “table salt,” which is an excessive nutrient, in “fries of bean sprouts and tofu” is in the range of 41% to 80%, −2 points are subtracted.

Since the pregnant weeks of the user during the recipe search are 5 weeks, the nutrients particularly necessary for the pregnant women are “folic acid” (one month before to third month), “calcium,” and “iron.” Referring to FIG. 14, since the sufficiency ratio of “folic acid,” which is a nutrient particularly necessary for the pregnant women, in “fries of bean sprouts and tofu” is in the range of 41% to 80%, +2 points are added. Since the sufficiency ratio of “calcium” in “fries of bean sprouts and tofu” is in the range of 41% to 80%, +2 points are added. Since the sufficiency ratio of “iron” in “fries of bean sprouts and tofu” is in the range of 41% to 80%, +2 points are added.

Accordingly, when the recipe “fries of bean sprouts and tofu” is scored, calculation can be performed as follows to get 12 points.

Score (fries of bean sprouts and tofu)=+2 (calcium)+2 (iron)+1 (vitamin D)+3 (dietary fiber)−2 (table salt)+2 (folic acid)+2 (calcium)+2 (iron)=12

By scoring the recipes of the search result list and displaying the recipes in a higher score order, an optimum recipe can be introduced to the user.

The morning sickness state (presence or absence) can be registered as the morning sickness information and the scores of the nutrients (here, vitamin B1 and vitamin B6) which are recommended to improve the symptom of the morning sickness according to the presence or absence of the morning sickness state can be added.

For example, when “morning sickness information” indicating that the user during the recipe search is “severe in morning sickness” is registered, the scores of “vitamin B1” and “vitamin B6” are added, as indicated by reference numeral 740.

### 2-10. Pregnancy Duration and Recommended Nutrients

In the system, information (corresponding to the first recommendation information) regarding nutrients which the user particularly eats in correspondence with a pregnancy duration or nutrients which the user is not allowed to eat can be stored as statistical information in the memory unit and a recipe appropriate for the pregnancy duration of the user searching the recipe using this information can be supplied.

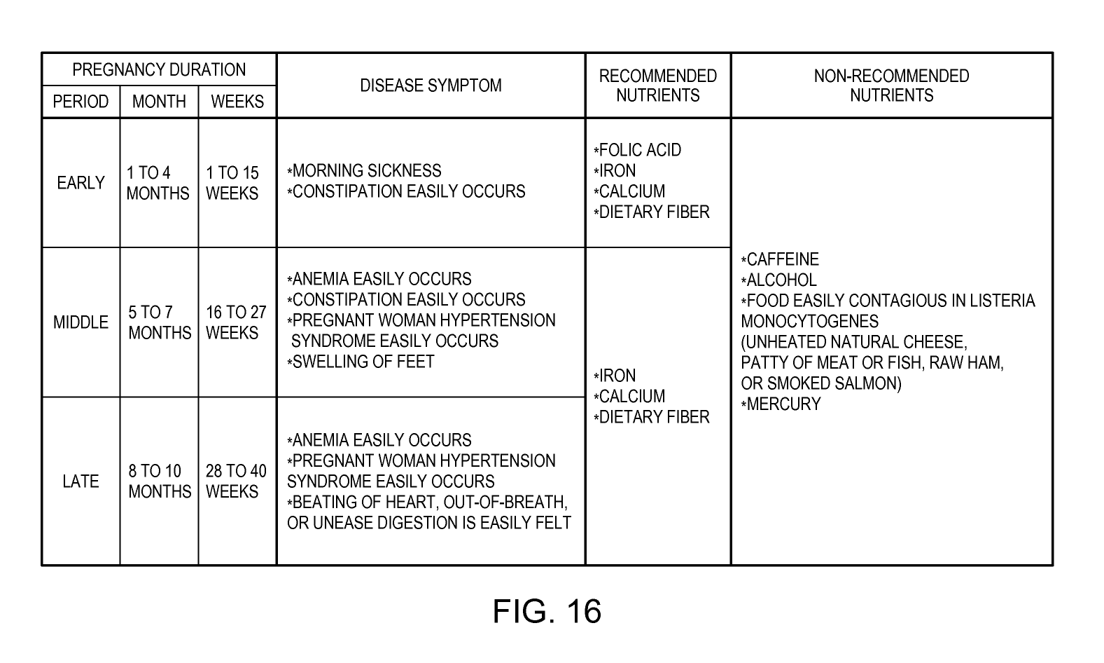

FIG. 16 is a diagram illustrating a relation table of recommended nutrients and non-recommended nutrients corresponding to pregnancy durations and disease states.

“Periods,” “months,” and “weeks” can be used as the pregnancy durations and can be properly used according to the pregnancy durations adopted in the system. For example, in the case of the system in which the pregnancy durations are managed as the user information using “periods,” the table is referred to using “periods.” In the case of the system in which the pregnancy durations are managed using “months,” the table is referred to using “months.” In the case of the system in which the pregnancy durations are managed using “weeks,” the table is referred to using “weeks.” Since the pregnancy durations are changed over time, “expected date of delivery” may be registered in advance as user information and the pregnancy durations (“periods,” “months,” and “weeks”) may be obtained from “expected date of delivery” and the current date.

The table of FIG. 16 indicates that the recommended nutrients are “folic acid,” “iron,” “calcium,” and “dietary fiber” when the pregnancy duration is “early pregnancy” (which may be“1 to 4 months” or “1 to 15 weeks”). The table indicates that the recommended nutrients are “iron,” “calcium,” and “dietary fiber” when the pregnancy duration is “middle pregnancy” (which may be“5 to 7 months” or “16 to 27 weeks”) or “late pregnancy” (which may be“8 to 10 months” or “28 to 40 weeks”).

The table indicates that the non-recommended nutrients are “caffeine,” “alcohol,” “food easily contagious in listeria monocytogenes,” and “mercury” when the pregnancy duration is “early pregnancy” (which may be“1 to 4 months” or “1 to 15 weeks”), the pregnancy duration is “middle pregnancy” (which may be“5 to 7 months” or “16 to 27 weeks”), or “late pregnancy” (which may be“8 to 10 months” or “28 to 40 weeks”).

For example, when the pregnancy duration of the user during the recipe search is “early period,” the score addition process or the score subtraction process may be performed on the recommended nutrients or the non-recommended nutrients corresponding to “early period” according to the sufficiency ratios of the recipe, as described in “2-9. Recipe Searching Process.” Apart from the scoring process, food containing the recommended nutrients corresponding to the pregnancy duration may be preferentially displayed. Further, food containing the non-recommended nutrients corresponding to the pregnancy duration may be excluded from the search result list.

In FIG. 16, symptoms easily occurring during the pregnancy duration are listed in “disease symptom.” The “disease symptom” is determined based on the information (438 in FIG. 4) registered by the user. When the pregnancy duration is the same, the degree of recommendation of the recommended nutrients may be set to be higher for the user registering the corresponding “disease symptom” than for the user not registering the “disease symptom.” For example, when the user in the early pregnancy registers the disease symptom “constipation easily occurs,” a process of setting added score ratios of the recommended nutrients to be high or preferentially displaying the added score ratios may be performed.

By doing so, the recipes tailored for the state of pregnant women can be supplied.

The embodiment and the modification examples have been described above, but the invention is not limited to the embodiment and the modification examples. The invention can be embodied in various aspects within the scope of the invention without departing from the gist of the invention.

The invention includes configurations which are substantially the same as the configurations described in the embodiment (for example, configurations of the same functions, methods, and results or configurations of the same objectives and advantages). The invention includes configurations in which portions which are not essential portions of the configurations described in the embodiment are substituted. The invention includes configurations in which the same operational advantages as those of the configurations described in the embodiment are obtained or configurations in which the same objectives can be achieved. The invention includes configurations in which known technologies described in the embodiment are added.

The entire disclosure of Japanese Patent Application No. 2014-071232, filed Mar. 31, 2014 is expressly incorporated by reference herein.

What is claimed is:

1. A nutrition management system comprising:
a memory unit that stores nutrition analysis result information regarding a nutrition state of a user obtained by analyzing a specimen collected from the user, user information including pregnancy duration information of the user, and dish information including food ingredient information used in a dish;
a user information calculation processing unit that performs a process of calculating a required nutrient amount of the user based on the user information and calculating nutrient excess or deficiency information of the user based on the required nutrient amount and the nutrition analysis result information of the user;
a dish information search processing unit that searches for the dish information based on an instruction from the user; and
a dish information calculation processing unit that calculates a nutrition amount acquirable from the dish of the dish information and supplies the dish information based on the nutrition amount and the nutrient excess or deficiency information of the user.

2. The nutrition management system according to claim 1,
wherein the user information includes meal history information of the user, and
wherein the user information calculation processing unit obtains nutrients acquirable from a meal history indicated by the meal history information of the user and calculates the nutrient excess or deficiency information of the user in addition to the nutrient.

3. The nutrition management system according to claim 1, wherein the dish information search processing unit performs evaluation by scoring the dish information, performs at least one of a process of adding a score when nutrients acquirable from the dish include a deficient nutrient of the user and a process of subtracting the score when the nutrients acquirable from the dish include an excessive nutrient of the user, and supplies the dish information according to the score.

4. The nutrition management system according to claim 1,
wherein the memory unit stores first recommendation information associating a length of a pregnancy duration of the user with at least one of a recommended nutrient, a recommended dish, and a recommended food ingredient, and
wherein the dish information search processing unit obtains at least one of the recommended nutrient, the recommended dish, and the recommended food ingredient according to the length of the pregnancy duration of the user based on the first recommendation information and the pregnancy duration of the user and evaluates the searched dish information based on at least the one of the recommended nutrient, the recommended dish, and the recommended food ingredient.

5. The nutrition management system according to claim 4,
wherein the first recommendation information includes information regarding at least one element among a nutrient, a dish, and a food ingredient which the user is allowed to particularly eat in correspondence with the pregnancy duration or regarding at least one element among a nutrient, a dish, and a food ingredient which the user is not allowed to eat,
wherein the user information calculation processing unit obtains a recommended element which the user is allowed to particularly eat or a non-recommended element which the user is not allowed to eat based on the first recommendation information and the pregnancy duration of the user, and
wherein the dish information search processing unit performs evaluation by scoring the dish information, performs at least one of a process of adding a score when elements acquirable from the dish include the recommended element and a process of subtracting the score when the elements include the non-recommended element, and supplies (displays) the dish information according to the score.

6. The nutrition management system according to claim 1,
wherein the user information includes commonly used supplement information regarding a supplement which the user eats periodically, and
wherein the user information calculation processing unit calculates the nutrient excess or deficiency information of the user in addition to a nutrient acquirable from the supplement indicated by the commonly used supplement information.

7. The nutrition management system according to claim 1,
wherein the user information includes morning sickness information regarding a morning sickness state of the user,
wherein the memory unit stores second recommendation information associating the morning sickness state with a recommended dish or a recommended food ingredient, and
wherein the dish information search processing unit obtains the recommended dish or the recommended food ingredient according to the morning sickness state of the user based on the second recommendation information and the morning sickness information of the user and evaluates the searched dish information based on the obtained recommended dish or recommended food ingredient.

8. The nutrition management system according to claim 1,
wherein the user information includes personal information,
wherein the personal information includes attribute information regarding at least one of sex, weight, age, activity level of the user, and
wherein the user information calculation processing unit calculates the required nutrient amount of the user based on at least the one of the sex, the weight, the age, and the activity level of the user and the pregnancy duration information of the user.

9. A nutrition management program causing a computer to function as:
a user information calculation processing unit that performs a process of calculating a required nutrient amount of a user based on user information and calculating nutrient excess or deficiency information of the user based on the required nutrient amount and nutrition analysis result information of the user;
a dish information search processing unit that searches for dish information based on an instruction from the user; and
a dish information calculation processing unit that calculates a nutrition amount acquirable from a dish of the dish information and supplies the dish information based on the nutrition amount and the nutrient excess or deficiency information of the user.

10. A server comprising:
a memory unit that stores nutrition analysis result information regarding a nutrition state of a user obtained by analyzing a specimen collected from the user, user information including pregnancy duration information of the user, and dish information including food ingredient information used in a dish;
a user information calculation processing unit that performs a process of calculating a required nutrient amount of the user based on the user information and calculating nutrient excess or deficiency information of the user based on the required nutrient amount and the nutrition analysis result information of the user;
a dish information search processing unit that searches for the dish information based on an instruction from the user; and
a dish information calculation processing unit that calculates a nutrition amount acquirable from the dish of the dish information and supplies the dish information based on the nutrition amount and the nutrient excess or deficiency information of the user.

11. A user terminal comprising:
an input unit that receives an instruction to search dish information from a user;
a communication unit that transmits the instruction to a server;
a dish information reception unit that is supplied with the dish information which is a research result from the server; and
a dish information supply unit that supplies the dish information to the user,
wherein the server calculates a required nutrient amount of the user based on user information including pregnancy duration information of the user, calculates nutrient excess or deficiency information of the user based on the required nutrient amount and nutrition analysis result information regarding a nutrition state of the user obtained by analyzing a specimen collected from the user, searches for the dish information based on an instruction from the user, calculates a nutrient amount acquirable from a dish of the dish information, and supplies the dish information based on the nutrient amount and the nutrient excess or deficiency information of the user.
